(19) United States
(12) Patent Application Publication
(10) Pub. No.: US 2007/0198489 A1
(43) Pub. Date: Aug. 23, 2007

(54) SYSTEM AND METHOD FOR SEARCHING WEB SITES FOR DATA

(75) Inventors: LIANG-PU LI, Shenzhen (CN); CHUNG-I LEE, Tu-Cheng (TW); CHIEN-FA YEH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/556,183

(22) Filed: Nov. 3, 2006

(30) Foreign Application Priority Data
Feb. 15, 2006 (CN) 200610033729.4

(51) Int. Cl. G06F 17/30

(52) U.S. Cl. 707/3

(57) ABSTRACT

The present invention provides a method for searching Web sites for data. The method includes the steps of: reading search conditions; converting the search conditions into extensible markup language (XML) search queries; parsing the XML search queries and accordingly creating XML commands; creating a command queue; defining attributes of the XML commands; adding the XML commands onto the command queue according to the XML commands' respective attributes; executing the XML commands to search for specified data on the Web sites; determines whether any specified data have been found on the Web sites; and downloading Web pages containing the specified data if the specified data are found on the Web sites. A related system is also disclosed.

### BACKGROUND OF THE INVENTION

1. Field of the Invention

The present invention relates to a system and a method for searching Web sites for data.

2. Description of Related Art

In recent years, with network data continually increasing, more and more search engines are provided to users for searching specified data through the Internet, or other kinds of network. However, some search engines are programmed and compiled by using a C++ programming language or a java™ programming language. Generally, functions of such search engines are simplex, and lack configurable abilities. For example, when the user needs to search on different Web sites that were developed by different programming languages, the search engines may not be adapted for some peculiar Web sites as their programming languages are different. Then, the search engines have to be reprogrammed, so as to meet the special Web sites. Thus, much time and manpower are wasted in reprogramming or re-compiling the search engines.

Furthermore, traditional search engines do not provide a function of parsing Web pages downloaded from the Web sites. For example, the user inputs a search condition for searching American patents issued on a certain date, and the search engines find that there are one hundred patents accord with the search condition. If the user wants to download the patents, he/she has to open and then download Web pages containing the patents through repetitive manual operations with the search engines. Thus, much time and resources are wasting in repetitive operations to acquire needed data, especially when the networks are busy. Moreover, some search engines require the user to input the search conditions in a predefined syntax format, which would require the user to know the predefined format well.

What is needed, therefore, is a system and method for searching Web sites for data that can convert formats of search conditions inputted by the users to a predetermined format, which is extensible to be adapted for different Web sites without complex operations. Furthermore, the system and method also can parse the Web pages downloaded to create more sub-commands, which are used for further searching or downloading specified Web pages automatically.

### SUMMARY OF THE INVENTION

A system for searching Web sites for data is provided. The system includes a reading module, a converting module, a parsing module, a command queue controlling module, and a searching module. The reading module is configured for reading search conditions. The converting module is configured for converting the search conditions into extensible markup language (XML) search queries. The parsing module is configured for parsing the XML search queries and accordingly creating XML commands. The command queue controlling module is configured for creating a command queue, for defining attributes of the XML commands, and for adding the XML commands onto the command queue according to the XML commands' respective attributes. The searching module is configured for executing the XML commands to search for specified data on the Web sites, and for downloading Web pages containing the specified data from the Web sites.

Furthermore, a method for searching Web sites for data is provided. The method includes the steps of: reading search conditions; converting the search conditions into extensible markup language (XML) search queries; parsing the XML search queries and accordingly creating XML commands; creating a command queue; defining attributes of the XML commands; adding the XML commands onto the command queue according to the XML commands' respective attributes; executing the XML commands to search for specified data on the Web sites; determines whether any specified data have been found on the Web sites; and downloading Web pages containing the specified data if the specified data are found on the Web sites.

Moreover, another system for searching Web sites for data is provided. The system includes a reading module, a converting module, a parsing module, a command queue controlling module, and a searching module. The reading module is configured for reading search conditions. The converting module is configured for converting the search conditions into search queries written in a programming language. The parsing module is configured for parsing the search queries and accordingly creating commands written in the programming language. The command queue controlling module is configured for creating a command queue, for defining attributes of the commands, and for adding the commands onto the command queue according to the commands' respective attributes. The searching module is configured for executing the commands to search for specified data on the Web sites, and for downloading Web pages containing the specified data from the Web sites.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for searching Web sites for data in accordance with a preferred embodiment;

FIG. 2 is a schematic diagram of main software function modules of the client computer of FIG. 1;

FIG. 3 is a schematic diagram of main software function modules of the computer of FIG. 1; and

FIG. 4 is a flowchart of a method for searching Web sites for data in accordance with a preferred embodiment.

### DETAILED DESCRIPTION OF THE INVENTION

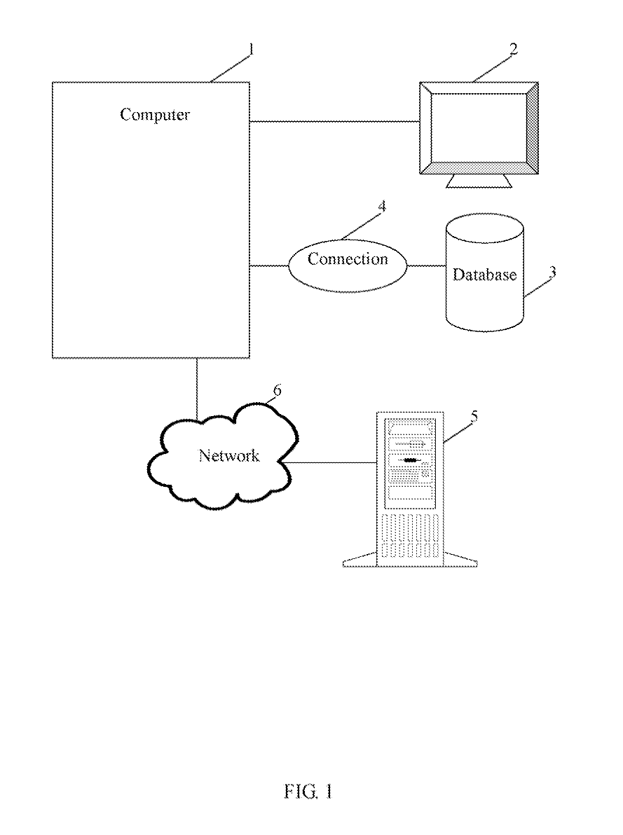

FIG. 1 is a schematic diagram of a hardware configuration of a system for searching Web sites for data in accordance with a preferred embodiment. The system for searching Web sites for data (hereinafter, “the system”) includes a computer 1, at least one client computer 2, at least one database 3, and at least one application server 5. The computer 1 is electronically connected with the client computer 2. The computer 1 and/or the client computer 2 may be a common computer, such as a personal computer, a laptop, a portable handheld device, a mobile phone, or other suitable electronic communication terminals. The client computer 2 provides an interactive user interface for inputting search conditions.

The computer 1 is further electronically connected with the database 3 via a connection 4. The database 3 is configured (i.e., structured and arranged) for storing various kinds of data that are downloaded via the application server 5, such as patent data and commercial data, etc. The connection 4 is typically a database connectivity, such as an open database connectivity (ODBC) or a Java database connectivity (JDBC).

Moreover, the computer 1 communicates with the application server 5 via a network 6. The network 6 may be an intranet, the Internet, or any other suitable type of communication links. The application server 5 is configured for linking/connecting Web servers (not shown) that host different Web sites therein via the network 6. The Web sites are sites (locations) on the World Wide Web (WWW), and are entire collections of Web pages and other data (such as images, sounds, and video files, etc.). The Web sites may be specified Web sites, such as patent data Web sites.

The computer 1 is configured for receiving the search conditions from the client computer 2, for processing the search conditions, for linking/connecting the Web servers through the application server 5, for searching for specified data on different Web sites, for downloading the Web pages containing the specified data from the Web sites (if the specified data are found), and for returning the Web pages as search results to the client computer 2. The computer 1 is further configured for parsing the Web pages to create sub-commands, which are configured for further searching or downloading other specified Web pages. The Web pages downloaded are stored in the database 3.

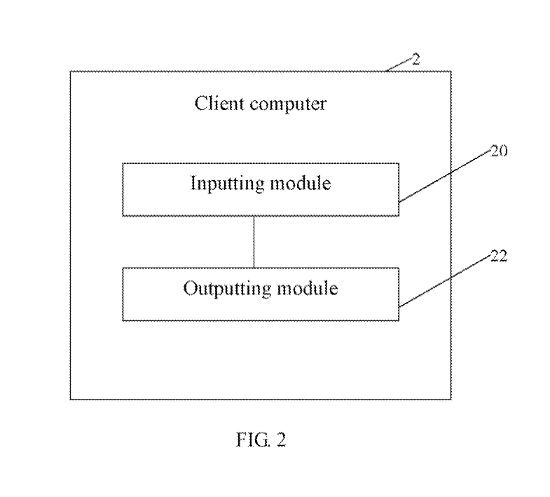

FIG. 2 is a schematic diagram of main software function modules of the client computer 2. The client computer 2 includes an inputting module 20 and an outputting module 22. The inputting module 20 is configured for prompting users to input the search conditions through the interactive user interface, and for transmitting the search conditions to the computer 1. The inputting module 20 is further configured for providing a function of specifying and/or selecting a uniform resource locator (URL) address. The function is used to specify the Web sites. Thus, the computer 1 searches and downloads the Web pages containing the specified data according to the specified Web sites.

The outputting module 22 is configured for outputting the Web pages downloaded by the computer 1 to the users through a monitor, a printer, or other peripheral equipments (not shown).

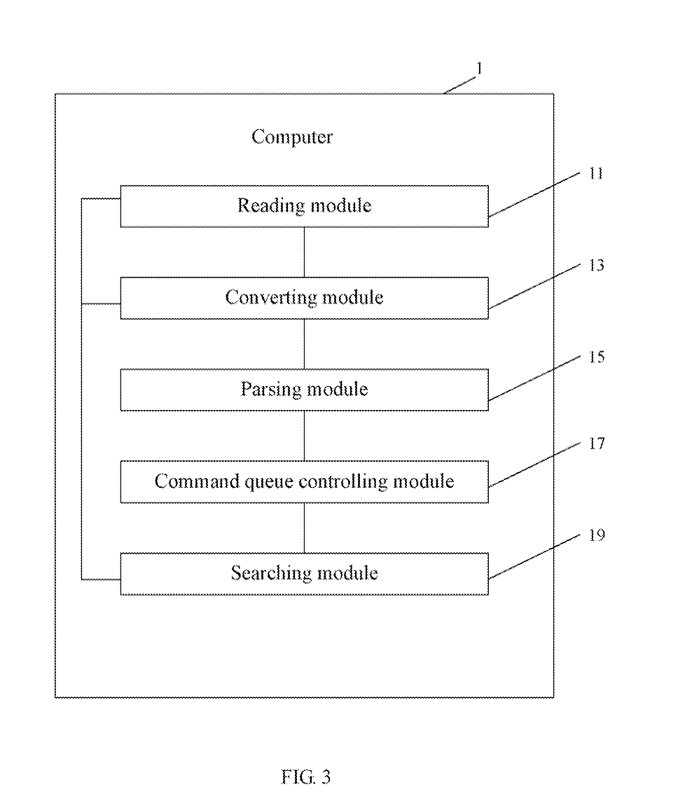

FIG. 3 is a schematic diagram of main software function modules of the computer 1. The computer 1 includes a reading module 11, a converting module 13, a parsing module 15, a command queue controlling module 17, and a searching module 19.

The reading module 11 is configured for receiving and reading the search conditions transmitted by the inputting module 20 of the client computer 2.

The converting module 13 is configured for converting the search conditions into search queries written in a programming language. In the preferred embodiment, the predetermined programming language is the extensible markup language (XML), and the search queries written in the XML are described as XML search queries hereinafter. The XML search queries provide flexible and standardized ways on searching XML data.

The XML format contains a series of elements and attributes. XML allows structuring data with user-defined tags. Basic requirements of the XML format may include: an XML declaration at the start of a document, explicit nesting of tags, and a root element. Furthermore, the elements are defined according to document type definition (DTD) documents or schema documents. For example, an XML document includes following XML sentences:

<book>
<title>action script: the definitive guide</title>
<author salutation=“mr.”>colin moock</author>
<publisher>o'reilly</publisher>
</book>

As shown in the above XML sentences, compositive elements of the XML document are “book”, “title”, “author”, and “publisher”; and an attribute of the XML document is “salutation”.

For example, if the user needs to search news of a company A and a company B in a Web site whose URL address is “http://tech.sina.com.cn/tele”, he/she inputs the search condition as ‘A or B’, and specifies the URL address as “http://tech.sina.com.cn/tele” through the inputting module 20. The reading module 11 reads the search condition transmitted by the inputting module 20, and the converting module 13 converts the search condition into the XML search queries. The converting process may include the following segments:

```
    let $keyword := ‘A OR “B”’
    return
    <command>
    <url>
    <address>http://tech.sina.com.cn/tele</address>
    <parsescript>sina_extract.xq</parsescript>
    <pagevariables>
    <pagevariable><name>url_flag</name><value> sina.tele</value>
</pagevariable>
    <pagevariable><name>keyword</name><value>{$keyword}</value>
</pagevariable>
    </pagevariables>
    </url>
    </command>
```

The parsing module 15 is configured for parsing the search queries into commands written in the programming language. In the preferred embodiment, the parsing module 15 parses the XML search queries and accordingly creates XML commands that are recognized and executed by the computer 1.

The command queue controlling module 17 is configured for creating a command queue, for defining attributes of the XML commands, and for adding the XML commands onto the command queue according to the XML commands' respective attributes. The command queue controlling module 17 is further configured for creating a queue handle for the command queue. The attributes of the XML commands control a sort order of the XML commands in the command queue.

The searching module 19 is configured for selecting the XML commands in the command queue, for executing the XML commands to search the Web sites for the specified data, for downloading the Web pages containing the specified data from the Web sites, for storing the Web pages into the database 3, and for returning the Web pages as the search results to the client computer 2 through the outputting module 22. The searching module 19 can be defined to select the XML commands in the command queue according to a predefined order. The searching module 19 is further configured for deleting the XML commands that have been executed from the command queue.

The converting module 13 is further configured for converting formats of the Web pages downloaded from the Web sites into the XML format. The parsing module 15 is further configured for creating XML sub-commands by parsing the Web pages converted.

For example, the searching module 19 searches for patents in a patent Web site, the searching module 19 may find a Web page containing fifty records, and then downloads the Web page. Each record corresponds to a patent specification. The converting module 13 converts the format of the Web page into the XML format, and the parsing module 15 creates fifty sub-commands by parsing the Web page. The fifty sub-commands are configured for downloading the fifty patent specifications.

For another example, if the searching module 19 downloads multiple Web pages relate to American issued patents with titles that include the keyword “computer”, and each Web page downloaded corresponds to each patent. The converting module 13 converts the hypertext markup language (HTML) format of the Web pages into the XML format. Furthermore, the Web pages may contain link references (URL addresses) to/of “images” on each Web page. The “images” links to a document containing specification and drawings of the corresponding patent. The parsing module 15 creates an XML sub-command for downloading the document of the corresponding patent by parsing each Web page. The command queue controlling module 17 defines attributes of the XML sub-commands, and adds the XML sub-commands onto the command queue according to the XML commands' respective attributes.

The searching module 19 is further configured for searching the specified data in local storage devices, such as the database 3. For example, if the user needs to search the specified data another time, he/she may search the database 3 for the Web pages containing the specified data through the searching module 19, and then the searching module 19 returns the Web pages to the client computer 2 directly without searching them on the Web sites, so as to save search time and resources.

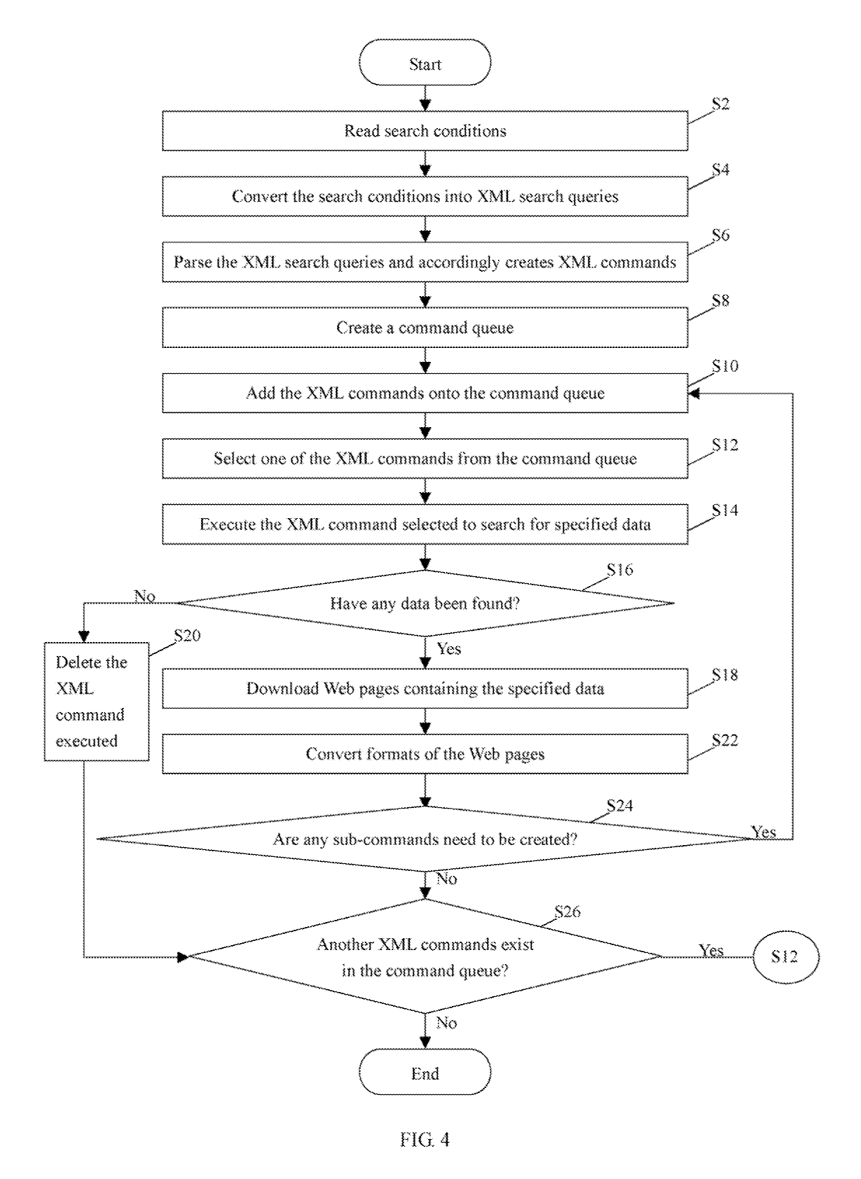

FIG. 4 is a flowchart of a method for searching Web sites for data. In step S2, the reading module 11 reads the search conditions transmitted from the client computer 2 through the inputting module 20. In step S4, the converting module 13 converts the search conditions into the XML search queries. In step S6, the parsing module 15 parses the XML search queries and accordingly creates the XML commands.

In step S8, the command queue controlling module 17 creates an empty command queue that has no command therein, and creates the queue handle for the command queue. In step S10, the command queue controlling module 17 defines the attributes of the XML commands, and adds the XML commands onto the command queue according to the XML commands' respective attributes. The attributes control a sort order of the XML commands in the command queue.

In step S12, the searching module 19 selects one of the XML commands from the command queue. In step S14, the searching module 19 executes the XML command selected to search the Web sites for the specified data, and the Web sites may be the specified Web sites. In step S16, the searching module 19 determines whether any specified data have been found on the Web sites. If the specified data have been found on the Web sites, in step S18, the searching module 19 downloads the Web pages containing the specified data from the Web sites, and deletes the XML command that has been executed from the command queue. Otherwise, if no specified data have been found on the Web sites, in step S20, the searching module 19 deletes the XML command that has been executed, and then the procedure directly goes to step S26.

In step S22, the converting module 13 converts the formats of the Web pages downloaded into the XML format. In step S24, the parsing module 15 parses the Web pages converted, and determines whether any XML sub-commands needs to be created. If so, the XML sub-commands are created by the parsing module 15, and the procedure returns to step S10. That is, the command queue controlling module 17 defines the attributes of the XML sub-commands, and adds the XML sub-commands onto the command queue.

If no XML sub-commands need to be created, in step S26, the searching module 19 determines whether another XML commands/sub-commands exist in the command queue. If one or more XML commands/sub-commands are in the command queue, the procedure returns to step S12, that is, the searching module 19 selects another XML command/sub-command from the command queue to execute. Otherwise, if no XML commands/sub-commands are in the command queue, the procedure ends.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for searching Web sites for data, comprising:
a reading module configured for reading search conditions;
a converting module configured for converting the search conditions into extensible markup language (XML) search queries;
a parsing module configured for parsing the XML search queries and accordingly creating XML commands;
a command queue controlling module configured for creating a command queue, for defining attributes of the XML commands, and for adding the XML commands onto the command queue according to the XML commands' respective attributes; and
a searching module configured for executing the XML commands to search for specified data on the Web sites, and for downloading Web pages containing the specified data from the Web sites.

2. The system as claimed in claim 1, wherein the reading module is further configured for returning the Web pages downloaded in response to the search conditions.

3. The system as claimed in claim 1, wherein the converting module is further configured for converting formats of the Web pages into the XML format.

4. The system as claimed in claim 3, wherein the parsing module is further configured for creating XML sub-commands by parsing the Web pages converted.

5. The system as claimed in claim 1, wherein the searching module is further configured for deleting the XML commands that have been executed from the command queue.

6. The system as claimed in claim 1, wherein the command queue controlling module is further configured for creating a queue handle for the command queue.

7. The system as claimed in claim 1, wherein the attributes of the XML commands control a sort order of the XML commands in the command queue.

8. A method for searching Web sites for data, comprising the steps of:
reading search conditions;
converting the search conditions into extensible markup language (XML) search queries;
parsing the XML search queries and accordingly creating XML commands;
creating a command queue;
defining attributes of the XML commands;
adding the XML commands onto the command queue according to the XML commands' respective attributes;
executing the XML commands to search for specified data on the Web sites;
determines whether any specified data have been found on the Web sites; and
downloading Web pages containing the specified data if the specified data are found on the Web sites.

9. The method according to claim 8, further comprising the step of returning the Web pages downloaded in response to the search conditions.

10. The method according to claim 8, further comprising the step of converting formats of the Web pages into the XML format.

11. The method according to claim 10, further comprising the step of creating XML sub-commands by parsing the Web pages converted.

12. The method according to claim 8, further comprising the step of deleting the XML commands that have been executed from the command queue.

13. The method according to claim 8, wherein the creating step comprising the step of creating a queue handle for the command queue.

14. The system as claimed in claim 8, wherein the attributes of the XML commands control a sort order of the XML commands in the command queue.

15. A system for searching Web sites for data, comprising:
a reading module configured for reading search conditions;
a converting module configured for converting the search conditions into search queries written in a programming language;
a parsing module configured for parsing the search queries and accordingly creating commands written in the programming language;
a command queue controlling module configured for creating a command queue, for defining attributes of the commands, and for adding the commands onto the command queue according to the commands' respective attributes; and
a searching module configured for executing the commands to search for specified data on the Web sites, and for downloading Web pages containing the specified data from the Web sites.

16. The system as claimed in claim 15, wherein the programming language is the extensible markup language.

17. The system as claimed in claim 15, wherein the converting module is further configured for converting formats of the Web pages into a format of the programming language.

18. The system as claimed in claim 17, wherein the parsing module is further configured for creating sub-commands in the programming language by parsing the Web pages converted.

19. The system as claimed in claim 15, wherein the searching module is further configured for deleting the commands that have been executed from the command queue.
